(19) United States
(12) Patent Application Publication
(10) Pub. No.: US 2023/0376447 A1
(43) Pub. Date: Nov. 23, 2023

(54) PARALLEL PROCESSING ARCHITECTURE WITH DUAL LOAD BUFFERS

(71) Applicant: Ascenium, Inc., Mountain View, CA (US)

(72) Inventor: Peter Foley, Los Altos Hills, CA (US)

(73) Assignee: Ascenium, Inc., Mountain View, CA (US)

(21) Appl. No.: 18/228,001

(22) Filed: Jul. 31, 2023

Related U.S. Application Data
(63) Continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/460,909, filed on Apr. 21, 2023.
(60) Provisional application No. 63/447,915, filed on Feb. 24, 2023.
(60) Provisional application No. 63/442,131, filed on Jan. 31, 2023.
(60) Provisional application No. 63/424,960, filed on Nov. 14, 2022.
(60) Provisional application No. 63/424,961, filed on Nov. 14, 2022.
(60) Provisional application No. 63/402,490, filed on Aug. 31, 2022.
(60) Provisional application No. 63/400,087, filed on Aug. 23, 2022.
(60) Provisional application No. 63/393,989, filed on Aug. 1, 2022.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.
(60) Provisional application No. 63/529,159, filed on Jul. 27, 2023.

(51) Int. Cl. G06F 15/80; G06F 12/0842

(52) U.S. Cl. CPC G06F 15/80; G06F 12/0842; G06F 2212/452

(57) ABSTRACT

Techniques for parallel processing based on a parallel processing architecture with dual load buffers are disclosed. A two-dimensional array of compute elements is accessed. Each compute element is known to a compiler and is coupled to its neighboring compute elements. A first data cache is coupled to the array. The first data cache enables loading data to a first portion of the array. The first data cache supports an address space. A second data cache is coupled to the array. The second data cache enables loading data to a second portion of the array. The second data cache supports the address space. Instructions are executed within the array. Instructions executed within the first portion of the array of compute elements use data loaded from the first data cache, and instructions executed within the second portion of the array of compute elements use data loaded from the second data cache.

### RELATED APPLICATIONS

This application claims the benefit of U.S. provisional patent applications “Parallel Processing Architecture With Dual Load Buffers” Ser. No. 63/393,989, filed Aug. 1, 2022, “Parallel Processing Architecture With Bin Packing” Ser. No. 63/400,087, filed Aug. 23, 2022, “Parallel Processing Architecture With Memory Block Transfers” Ser. No. 63/402,490, filed Aug. 31, 2022, “Parallel Processing Using Hazard Detection And Mitigation” Ser. No. 63/424,960, filed Nov. 14, 2022, “Parallel Processing With Switch Block Execution” Ser. No. 63/424,961, filed Nov. 14, 2022, “Parallel Processing With Hazard Detection And Store Probes” Ser. No. 63/442,131, filed Jan. 31, 2023, “Parallel Processing Architecture For Branch Path Suppression” Ser. No. 63/447,915, filed Feb. 24, 2023, “Parallel Processing Hazard Mitigation Avoidance” Ser. No. 63/460,909, filed Apr. 21, 2023, and “Parallel Processing Architecture With Block Move Support” Ser. No. 63/529,159, filed Jul. 27, 2023.

This application is also a continuation-in-part of U.S. patent application “Highly Parallel Processing Architecture With Compiler” Ser. No. 17/526,003, filed Nov. 15, 2021, which claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. patent application “Highly Parallel Processing Architecture With Compiler” Ser. No. 17/526,003, filed Nov. 15, 2021 is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to parallel processing and more particularly to a parallel processing architecture with dual load buffers.

### BACKGROUND

“Many hands make light work” is an ancient idiom that remains true today. Our interconnected world routinely creates opportunities for volumes of work that far exceed the capacities of one person or one machine. From the earliest times of civilizations, humans working together have been able to achieve great feats of architecture, engineering, food production, communication, transportation, and so on. As humans organized themselves and took on various projects that demanded the efforts of more than one person, the idea that combining two general solutions to get work done took shape. Dividing different types of work so that those who were best at one particular task or sets of related tasks could work together on those tasks led to specialized jobs. Some fished while others hunted, some farmed while others baked bread, some sewed garments while others built houses, and so on. Large work efforts often combined the skills of many different groups, laboring at different times, or in different areas at the same time. Small towns and large cities alike required people to build roads and bridges, homes and workplaces; create ways to move and store water and food; build walls for protection; and so on. These requirements have not changed today. Even though the technology surrounding the labor may have changed, the basic requirements are the same—food and shelter, protection from the elements, and the ability to communicate, to travel, to interact, are all still vitally important.

Along with the division of labor into specialized fields of endeavor, the ability to divide large amounts of the same type of work across many workers is equally necessary. Armies are made up of many soldiers trained and equipped the same way. Grocery stores employ scores of checkout clerks all doing the same task alongside each other. Toll booths handle thousands of cars, trucks, buses, and vans on a daily basis, with some being automated and others holding one or two workers at a time. Cities hold hundreds of delivery workers on bicycles, rickshaws, motorcycles, and scooters. Accounting firms employ scores of accountants; legal firms use many lawyers; and construction sites hire numerous welders, iron workers, riggers, and so on. Volumes of work routinely require multiple workers doing the same thing at the same time, repeating the same tasks over and over again until all of the individual jobs are completed.

The same sorts of work efforts are true in the machine world. Textile factories house hundreds of automated looms generating fabrics at an astonishing rate. Food processing plants house vast ovens working side by side to bake bread. Automobile factories turn out scores of cars and trucks from multiple assembly lines, combining highly specialized groups of laborers with robots repeating the same tasks again and again in exactly the same way. Manufacturing plants across the globe turn out thousands of products to the same specifications, so that a light bulb made in Singapore or Taiwan works in the same way as one made in Mexico or California. Likewise, digital computing employs both divisions of specialized labor and multiple devices doing the same work side by side. Computers large and small include central processing units, memory units, storage systems, temperature management, power management, user interface systems, and so on. Connections to keyboards, mice, video screens, cameras, light pens, speakers, and so on readily demonstrate specialized labor at a glance. As these components and connections become more and more complicated, it is imperative that they work together efficiently.

### SUMMARY

A wide variety of organizations execute substantial numbers of processing jobs. Each of the executed jobs can be critical to the goals, missions, and indeed survival of the organizations. Typical processing jobs include running payroll, analyzing research data, or training a neural network for applications including machine learning. These jobs are highly complex and are constructed from many tasks. The tasks can include loading and storing various datasets, accessing processing components and systems, executing data processing, and so on. The tasks themselves are frequently based on subtasks which themselves can be complex. The subtasks can be used to handle specific jobs such as loading or reading data from storage, performing computations and other manipulations on the data, storing or writing the data back to storage, enabling inter-subtask communication such as data transfer and control, and so on. The datasets that are accessed are vast and can easily overwhelm processing architectures that are either poorly suited for the processing tasks or are based on inflexible designs. To greatly improve the efficiency and the throughput of task processing, two-dimensional (2D) arrays of elements can be used for task and subtask processing. The 2D arrays include compute elements, multiplier elements, registers, caches, queues, controllers, decompressors, arithmetic logic units (ALUs), multipliers, storage elements, and other components which can communicate among themselves. These arrays of elements are configured and operated by providing control to the array of elements on a cycle-by-cycle basis. The control of the 2D array is accomplished by providing a stream of wide control words generated by a compiler. The stream of control words can further include wide, computer-generated control words. The control words are used to configure the array, to control the flow or transfer of data, and to manage the processing of the tasks and subtasks. Further, the arrays can be configured in a topology which is best suited to the task processing. The topologies into which the arrays can be configured include a systolic, a vector, a cyclic, a spatial, a streaming, or a Very Long Instruction Word (VLIW) topology, among others. The topologies can include a topology that enables machine learning functionality.

Processing is based on a parallel processing architecture with dual load buffers. A two-dimensional (2D) array of compute elements is accessed, wherein each compute element within the array of compute elements is known to a compiler and is coupled to its neighboring compute elements within the array of compute elements. A first data cache is coupled to the array of compute elements, wherein the first data cache enables loading data to a first portion of the array of compute elements, and wherein the first data cache supports an address space. A second data cache is coupled to the array of compute elements, wherein the second data cache enables loading data to a second portion of the array of compute elements, and wherein the second data cache supports the address space. Instructions are executed within the array of compute elements, wherein instructions executed within the first portion of the array of compute elements use data loaded from the first data cache, and wherein instructions executed within the second portion of the array of compute elements use data loaded from the second data cache.

A processor-implemented method for parallel processing is disclosed comprising: accessing a two-dimensional array of compute elements, wherein each compute element within the array of compute elements is known to a compiler and is coupled to its neighboring compute elements within the array of compute elements; coupling a first data cache to the array of compute elements, wherein the first data cache enables loading data to a first portion of the array of compute elements, and wherein the first data cache supports an address space; coupling a second data cache to the array of compute elements, wherein the second data cache enables loading data to a second portion of the array of compute elements, and wherein the second data cache supports the address space; and executing instructions within the array of compute elements, wherein instructions executed within the first portion of the array of compute elements use data loaded from the first data cache, and wherein instructions executed within the second portion of the array of compute elements use data loaded from the second data cache. In embodiments, the address space is a common address space supported simultaneously by both the first data cache and the second data cache. Some embodiments comprise maintaining coherence between the first data cache and the second data cache. In embodiments, the coherence is maintained by storing store data from within the array of compute elements to both the first data cache and the second data cache. In embodiments, the store data is stored to the first data cache and the second data cache in parallel. In embodiments, the store data is tagged with precedence information. And in embodiments, the precedence information is determined by the compiler.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a parallel processing architecture with dual load buffers.

FIG. 2 is a flow diagram for maintaining data coherence.

FIG. 3A is a system block diagram showing caches and buffers.

FIG. 3B is a system block diagram for a compute element.

FIG. 4 illustrates a system block diagram for a highly parallel architecture with a shallow pipeline.

FIG. 5 shows compute element array detail.

FIG. 6 illustrates a system block diagram for compiler interactions.

FIG. 7 is a system diagram for a parallel processing architecture with dual load buffers.

### DETAILED DESCRIPTION

Techniques for a parallel processing architecture with dual load buffers are disclosed. A load buffer can be located between a storage element and a two-dimensional (2D) array of compute elements. The storage element can include a memory system, cache memory, register files, and so on. The load buffer can receive or accumulate data resulting from a load request originating from an operation, instruction, etc. associated with a task, subtask, or process being executed within the 2D array. The data within the load buffer can be provided to the 2D array of compute elements using one or more buses, unidirectional buses, communication channels, and the like. By adding a second or dual load buffer, the load bandwidth of the first load buffer is essentially doubled. The dual load buffers can be coupled to opposite sides of the 2D array. Since the propagation delay associated with loading data into the array is directly dependent on the dimensions of the array, lengths of buses or communication channels, and the like, providing the data from two sides of the array effectively divides the propagation delay by two. Further, the coupling of dual load buffers to the 2D array enables use of a second cache such as a second data cache. The second data cache can include data which is substantially similar to data within the first data cache, thereby enhancing the loading of the data into the 2D array. Further, use of the second cache increases an overall amount of cache, further speeding data load requests by reducing load requests to a memory system or other slower storage element.

Each of the load buffers can comprise a memory element, where the memory element can include an element with two read ports and one write port (2R1 W). The 2R1 W memory element enables two read operations and one write operation to occur substantially simultaneously. Data within the dual load buffers can be distributed to one or more compute elements within the 2D array of compute elements, where the compute elements are configured to execute tasks, subtasks, processes, etc. The tasks and subtasks that are executed can be associated with a wide range of applications based on data manipulations, such as image or audio processing applications, AI applications, business applications, data processing and analysis, and so on. The tasks that are executed can perform a variety of operations including arithmetic operations, shift operations, logical operations including Boolean operations, vector or matrix operations, tensor operations, and the like. The subtasks can be executed based on precedence, priority, coding order, amount of parallelization, data flow, data availability, compute element availability, communication channel availability, and so on.

The data manipulations are performed on a two-dimensional (2D) array of compute elements. The compute elements within the 2D array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage which can include local memory elements, register files, cache storage, etc. The cache, which can include a hierarchical cache such as a level 1 (L1), a level 2 (L2), and a level 3 (L3) cache working together, can be used for storing data such as intermediate results, compressed control words, coalesced control words, decompressed control words, relevant portions of a control word, and the like. The cache can store data produced by a taken branch path, where the taken branch path is determined by a branch decision. The decompressed control word is used to control one or more compute elements within the array of compute elements. Multiple layers of the two-dimensional array of compute elements can be “stacked” to comprise a three-dimensional array of compute elements.

The tasks, subtasks, etc. that are associated with processing operations are generated by a compiler. The compiler can include a general-purpose compiler, a hardware description-based compiler, a compiler written or “tuned” for the array of compute elements, a constraint-based compiler, a satisfiability-based compiler (SAT solver), and so on. Control is provided to the hardware in the form of control words, where one or more control words are generated by the compiler. The control words are provided to the array on a cycle-by-cycle basis. The control words can include wide microcode control words, variable-length control words, fixed-width control words, etc. The length of a control word such as a microcode control word can be adjusted by compressing the control word. The compressing can be accomplished by recognizing situations where a compute element is unneeded by a task. Thus, control bits within the control word associated with the unneeded compute elements are not required for that compute element. Other compression techniques can also be applied. The control words can be used to route data, to set up operations to be performed by the compute elements, to idle individual compute elements or rows and/or columns of compute elements, etc. The compiled microcode control words associated with the compute elements are distributed to the compute elements. The compute elements are controlled by a control unit which decompresses the control words. The decompressed control words enable processing by the compute elements. The task processing is enabled by executing the one or more control words. In order to accelerate the execution of tasks, to reduce or eliminate stalling for the array of compute elements, and so on, copies of data can be broadcast to a plurality of physical register files comprising 2R1 W memory elements. The register files can be distributed across the 2D array of compute elements.

Parallel processing is enabled by a parallel processing architecture with dual load buffers. The parallel processing can include data manipulation. A two-dimensional array of compute elements is accessed, wherein each compute element within the array of compute elements is known to a compiler and is coupled to its neighboring compute elements within the array of compute elements. The compute elements can include compute (computation) elements, processors, or cores within an integrated circuit; processors or cores within an application specific integrated circuit (ASIC); cores programmed within a programmable device such as a field programmable gate array (FPGA); and so on. The compute elements can include homogeneous or heterogeneous processors. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. Thus, the compiler can control data flow between and among the compute elements and can further control data commitment to storage or memory outside of the array.

A first data cache is coupled to the array of compute elements. The first data cache can include a small, fast memory which can be located close to the 2D array of compute elements. The first data cache can include a multilevel cache, where the multilevel cache can include a level 1 (L1) cache and a level 2 (L2) cache. The first data cache enables loading data to a first portion of the array of compute elements. The first portion of the array of compute elements can include one or more compute elements within a region of the array. The first data cache supports an address space such as an address space accessible to the first portion of the array. A second data cache is coupled to the array of compute elements. The second data cache can also include a small, fast memory which can be located close to the 2D array of compute elements. The second data cache can include a multilevel cache. The second data cache enables loading data to a second portion of the array of compute elements. The second portion of the array of compute elements can include one or more compute elements not included within the first portion associated with the first data cache. The second data cache supports an address space such as an address space that is accessible to the second portion of the array.

The array of compute elements is controlled on a cycle-by-cycle basis, wherein the controlling is enabled by a stream of wide control words generated by the compiler. A cycle can include a clock cycle, an architectural cycle, a system cycle, etc. The stream of wide control words generated by the compiler provides direct, fine-grained control of the 2D array of compute elements. The fine-grained control can include control of individual compute elements, memory elements, control elements, etc. Operations contained in the control words are executed by the compute elements. The operations are enabled by at least one of a plurality of distributed physical register files. Instructions are executed within the array of compute elements. The instructions that are extracted from the stream of control words are provided by the compiler. Instructions executed within the first portion of the array of compute elements use data loaded from the first data cache, and instructions executed within the second portion of the array of compute elements use data loaded from the second data cache. Loading the instructions from the two data caches effectively doubles load bandwidth, thereby reducing load times.

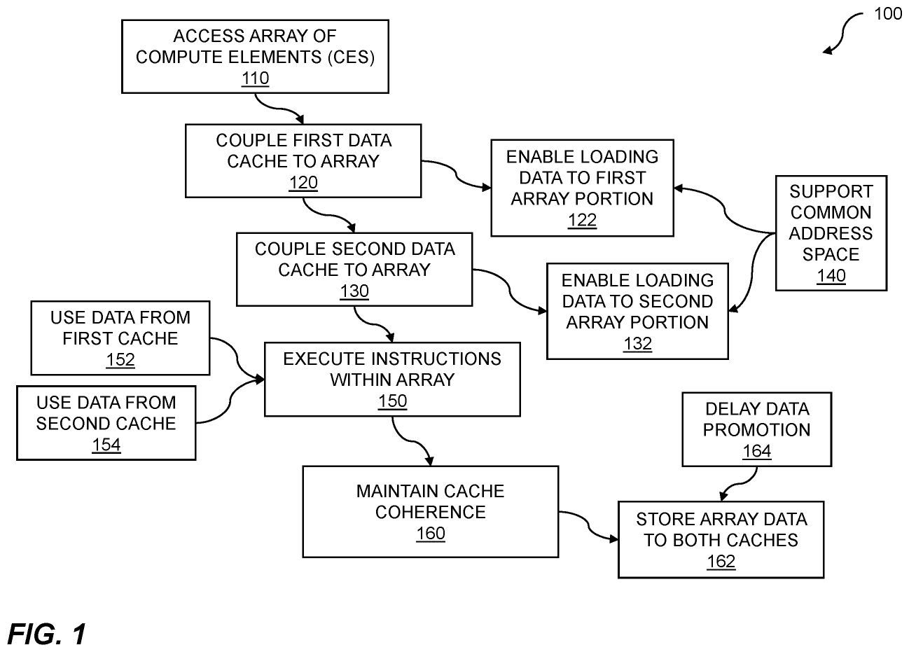

FIG. 1 is a flow diagram for a parallel processing architecture with dual load buffers. Groupings of compute elements (CEs), such as CEs assembled within a 2D array of CEs, can be configured to execute a variety of operations associated with data processing. The operations can be based on tasks and on subtasks that are associated with the tasks. The 2D array can further interface with other elements such as controllers, storage elements, ALUs, memory management units (MMUs), GPUs, multiplier elements, and so on. The operations can accomplish a variety of processing objectives such as application processing, data manipulation, data analysis, and so on. The operations can manipulate a variety of data types including integer, real, and character data types; vectors and matrices; tensors; etc. A first data cache is coupled to the array of compute elements. The first data cache enables loading data to a first portion of the array of compute elements. The first data cache supports an address space. A second data cache is coupled to the array of compute elements. The second data cache enables loading data to a second portion of the array of compute elements, and the second data cache supports the address space.

Control is provided to the array of compute elements on a cycle-by-cycle basis, where the control is based on control words generated by a compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence data provision and compute element results. The control enables execution of a compiled program on the array of compute elements. Instructions are executed within the array of compute elements. Instructions executed within the first portion of the array of compute elements use data loaded from the first data cache, and instructions executed within the second portion of the array of compute elements use data loaded from the second data cache. Coherence is maintained between the first data cache and the second data cache. The coherence is maintained by storing store data from within the array of compute elements to both the first data cache and the second data cache, where the storing can be accomplished in parallel. The store data is tagged with precedence information. The precedence information associated with store datasets is compared to determine a precedence between datasets. The comparing precedence between datasets can be used to avoid storage, memory, and cache access hazards.

The flow 100 includes accessing a two-dimensional (2D) array 110 of compute elements, wherein each compute element within the array of compute elements is known to a compiler and is coupled to its neighboring compute elements within the array of compute elements. The compute elements can be based on a variety of types of processors. The compute elements, or CEs, can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be collocated within a single integrated circuit or chip. The compute elements can be configured in a topology, where the topology can be built into the array, programmed or configured within the array, etc. In embodiments, the array of compute elements is configured by a control word that can implement a topology. The topology that can be implemented can include one or more of a systolic, a vector, a cyclic, a spatial, a streaming, or a Very Long Instruction Word (VLIW) topology.

The compute elements within the 2D array of compute elements can be configured into additional topologies. The compute element configurations can further include a topology suited to machine learning computation. A topology for machine learning can include supervised learning, unsupervised learning, reinforcement learning, and other machine learning topologies. The compute elements can be coupled to other elements within the array of CEs. In embodiments, the coupling of the compute elements can enable one or more further topologies. The other elements to which the CEs can be coupled can include storage elements such as one or more levels of cache storage; control units; multiplier units; address generator units for generating load (LD) and store (ST) addresses; queues; register files; and so on. The compiler to which each compute element is known can include a C, C++, or Python compiler. The compiler to which each compute element is known can include a compiler written especially for the array of compute elements. The coupling of each CE to its neighboring CEs enables clustering of compute resources; sharing of elements such as cache elements, multiplier elements, ALU elements, or control elements; communication between or among neighboring CEs; and the like.

The one or more control words are generated by a compiler. The compiler which generates the control words can include a general-purpose compiler such as a C, C++, or Python compiler; a hardware description language compiler such as a VHDL or Verilog compiler; a compiler written for the array of compute elements; and the like. In embodiments, the wide control words comprise variable length control words. The control words can be of variable length for various reasons, for example, so that a different number of operations for a differing plurality of compute elements can be conveyed in each control word. In embodiments, the stream of wide control words generated by the compiler provides direct fine-grained control of the 2D array of compute elements. The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NN) implementation. The neural network implementation can include a plurality of layers, where the layers can include one or more of input layers, hidden layers, output layers, and the like. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data and no control word. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

The control words that are generated by the compiler can include a conditionality such as a branch. The branch can include a conditional branch, an unconditional branch, etc. The control words can be decompressed by a decompressor logic block that decompresses words from a compressed control word cache on their way to the array. In embodiments, the set of directions can include a spatial allocation of subtasks on one or more compute elements within the array of compute elements. In other embodiments, the set of directions can enable multiple, simultaneous programming loop instances circulating within the array of compute elements. The multiple programming loop instances can include multiple instances of the same programming loop, multiple programming loops, etc.

The flow 100 includes coupling 120 a first data cache to the array of compute elements. The first data cache can be used to store data such as data associated with processes, tasks, subtasks, etc. which can be executed using one or more compute elements within the 2D array of compute elements. The first data cache can further be used to hold control words, intermediate results, microcode, branch decisions, and so on. The first data cache can comprise a small, local, easily accessible memory available to one or more compute elements. In the flow 100, the first data cache enables loading 122 data to a first portion of the array of compute elements. The portion of the array of compute elements can include one or more compute elements, pairs or quads of compute elements, a region or quadrant of the compute element array, and so on. The flow 100 includes coupling 130 a second data cache to the array of compute elements. The second data cache, much as the first data cache, can be used to store data such as data associated with processes, tasks, subtasks, etc. The processes, tasks, and subtasks can be executed using one or more compute elements within the 2D array of compute elements. The second data cache can further be used to hold control words, intermediate results, etc. The second data cache can further comprise a small, local, easily accessible memory available to one or more compute elements. In the flow 100, the second data cache enables loading 132 data to a second portion of the array of compute elements. The second portion of the array of compute elements can include one or more compute elements, pairs or quads of compute elements, compute elements not located within the first portion of the array, etc.

The first data cache and the second data cache can include single level caches, multilevel caches, and so on. In embodiments, the first data cache and the second data cache each can include a level 1/level 2 (L1/L2) cache bank. A cache bank can be addressed sequentially. Data can be moved from storage such as a memory system to the first data cache and the second data cache as blocks, pages, etc. The data can be moved between storage and the data caches using cache lines. In embodiments, cache lines in each L2 of the first data cache and the second data cache can include an age counter. The age counter can be used to determine a number of cycles, an amount of time, and so on that has elapsed since a cache line was transferred to the first data cache or the second data cache. The age counter can further indicate a “time to live”. The age counter can be used by a least-recently-used (LRU) technique to determine whether a cache line should be swapped out of the first data cache or the second data cache. In further embodiments, the age counter can establish precedence for a unified level 3 (L3) cache coupled to the first data cache and the second data cache. The unified L3 cache can store data, control words, compressed control words, instructions, directions, and so on. In embodiments, the first data cache L1/L2 cache bank and the second data cache L1/L2 cache bank can employ a write-back policy. A write-back policy can be used to minimize a number of times or a frequency at which changed data is written to cache and to main storage such as a memory system. In a usage example, data is written to the cache each time a change to data is made. Instead of writing data back to main storage every time data is changed, the changed data can be written back to the main storage based on a number of cycles, an amount of time, a condition such as a threshold being met, etc.

The first data cache can enable load data to a first portion of the array of compute elements. The second data cache can enable load data to a second portion of the array of compute elements. In the flow 100 the first data cache and the second data cache support 140 an address space. In embodiments, the address space can be a common address space supported simultaneously by both the first data cache and the second data cache. The common address space can enable access to substantially similar data. The address space can be accessible by compute elements within the 2D array of compute elements. Embodiments include storing relevant portions of a control word within the first data cache and the second data cache, each of which is associated with the array of compute elements. The caches can be accessible to one or more compute elements within a first portion and a second portion of the array. The caches can include a dual read, single write (2R1 W) cache. That is, a 2R1 W cache can enable two read operations and one write operation contemporaneously without the read and write operations interfering with one another.

The flow 100 includes executing instructions 150 within the array of compute elements. The instructions can be obtained from the first data cache, from the second data cache, from a memory system, and so on. The instructions can be derived or extracted from control words, compressed control words, variable-length control words, wide control words, and the like. In the flow 100, instructions executed within the first portion of the array of compute elements use data 152 loaded from the first data cache. The first data cache can be located adjacent to the first portion of the array. In the flow 100, instructions executed within the second portion of the array of compute elements use data 154 loaded from the second data cache. The second data cache can be located adjacent to the second portion of the array. The data loaded from the first data cache and the data loaded from the second data cache can be substantially similar or can be substantially different. The data loaded from the first data cache can be loaded from a different portion of the cache than the data loaded from the second data cache. In a usage example, the data loaded from the first data cache can represent tasks and subtasks different from the tasks and subtasks represented by the data loaded from the second data cache.

The instructions that are executed within the first portion of the 2D array of compute elements and the second portion of the 2D array can be contained in a control word from a stream of control words. In embodiments, a control word in the stream of control words can include a data dependent branch operation. A data dependent branch operation can be based on a logical expression, an arithmetic operation, etc. A branch condition signal could also be imported from a neighboring compute element that is operating autonomously from the control unit, but cooperatively in a compute element grouping, as will be described later. Since a data dependent branch can cause the order of execution of operations to change, a latency can occur if new operations or different data must be obtained. This latency may be avoidable when operating autonomously out of a bunch buffer. In embodiments, the compiler can calculate a latency for the data dependent branch operation. The compiler can include operations to prefetch instructions, prefetch data if available, etc. In embodiments, the latency can be scheduled into compute element operations. Additional operations can be executed.

The instructions can be based on one or more operations. Discussed above and throughout, operations that are executed can be associated with a task, a subtask, and so on. The operations can include arithmetic, logic, array, matrix, tensor, and other operations. A number of iterations of executing operations can be accomplished based on the contents of an operation counter within a given compute element. The particular operation or operations that are executed in a given cycle can be determined by the set of control word operations. More than one control word can be grouped into a “bunch” to provide operational control of a particular compute element. The compute element can be enabled for operation execution, can be idled for a number of cycles when the compute element is not needed, etc. Operations that are executed can be repeated. In embodiments, each set of instructions associated with one or more control words can enable operational control of a particular compute element for a discrete cycle of operations. An operation can be based on the plurality of control bunches (e.g., sequences of operations) for a given compute element. The operation that is being executed can include data dependent operations. In embodiments, the plurality of control words includes two or more data dependent branch operations. The branch operation can include two or more branches where a branch is selected based on an operation such as an arithmetic or logical operation. In a usage example, a branch operation can determine the outcome of an expression such as A>B. If A is greater than B, then one branch can be taken. If A is less than or equal to B, then another branch can be taken. In order to speed execution of a branch operation, sides of the branch can be precomputed prior to datum A and datum B being available. When the data is available, the expression can be computed, and the proper branch direction can be chosen. The untaken branch data and operations can be discarded, flushed, etc. In embodiments, the two or more data dependent branch operations can require a balanced number of execution cycles. The balanced number of execution cycles can reduce or eliminate idle cycles, stalling, and the like. In embodiments, the balanced number of execution cycles is determined by the compiler. In embodiments, the accessing, the providing, the loading, and the executing can enable background memory accesses. The background memory access enables a control element to access memory independently of other compute elements, a controller, etc. In embodiments, the background memory accesses can reduce load latency. Load latency is reduced since a compute element can access memory before the compute element exhausts the data that the compute element is processing.

The flow 100 further includes maintaining coherence 160 between the first data cache and the second data cache. Coherence such as cache coherence can include a consistency of the data stored in multiple caches. Here, the cache coherence includes consistency of the data within data cache one relative to the data within data cache two. That is, if data is updated within one of the data caches, then the data within the other data cache must also be updated to maintain coherence between the two data caches. A variety of techniques can be used for maintaining coherence between the first data cache and the second data cache. In embodiments, the compiler can generate a time delay to enable store coherence between the first data cache and the second data cache. The time delay can be based on cycles such as architectural cycles, physical cycles, and so on. The time delay can be based on an amount of time such as “wall clock” time. During the time delay, coherence between the first data cache and the second data cache can be accomplished by storing store data to the first data cache and the second data cache in parallel. The coherence between the data caches can be accomplished by identifying discrepancies between the first data cache and the second data cache and by rectifying those discrepancies and storing valid store data. In embodiments, the first data cache and the second data cache can each include dedicated load buffers, crossbar switches, and access buffers. The load buffers can accumulate data loaded from the cache for provision to one or more compute elements within the 2D array of compute elements. The crossbar switches can be used to direct load data to the proper load buffers, to shift or rotate load data, etc. The access buffers can hold data loaded from the first data cache or the second data cache, can hold data to be stored into the data caches, and so on.

In the flow 100, the coherence is maintained by storing 162 store data from within the array of compute elements to both the first data cache and the second data cache. The storing the data can be based on transferring one or more bytes, words, blocks, and so on of data to both data caches. In embodiments, the store data can be stored to the first data cache and the second data cache in parallel. Discussed previously and throughout, the store data can be tagged. In embodiments, the store data can be tagged with precedence information. The precedence information can include a priority, a number of cycles, an amount of time (e.g., time to live), and so on. In embodiments, the precedence information that is used to tag the store data can be determined by the compiler. Recall that the compiler can provide control for compute elements on a cycle-by-cycle basis, and that control for the compute elements can be enabled by a stream of wide control words generated by the compiler. The control words configure one or more compute elements within the 2D array of compute elements; provide directions, instructions, or operations; control data flow, etc. In embodiments, the control words can include the precedence information. The precedence information can indicate order of operation, priorities, and so on.

In embodiments, the precedence information can enable hazard detection. Discussed throughout, hazards such as data hazards can exist when two or more instructions, operations, etc., require access to the same address. In order for valid data to be read from and new data to be written to the same address, the order of reading and writing must be coordinated to avoid overwriting valid data, reading stale data, etc. The flow 100 further includes delaying 164 the promoting of the store data. The promoting the store data can include storing the store data within the first data cache, the second data cache, a memory system, etc. In embodiments, the delaying can avoid hazards. The hazards can include loading (reading) invalid or stale data, storing (writing) new data over valid data, and so on. In embodiments, the hazards can include write-after-read, read-after-write, and write-after-write conflicts. The hazards can further include structural or resource hazards, control hazards such as branch hazards, etc. In embodiments, the avoiding hazards can be based on a comparative precedence value. By comparing precedence values associated with store data operations, the operations can be executed such that an order of operation is maintained to prevent possible data hazards.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

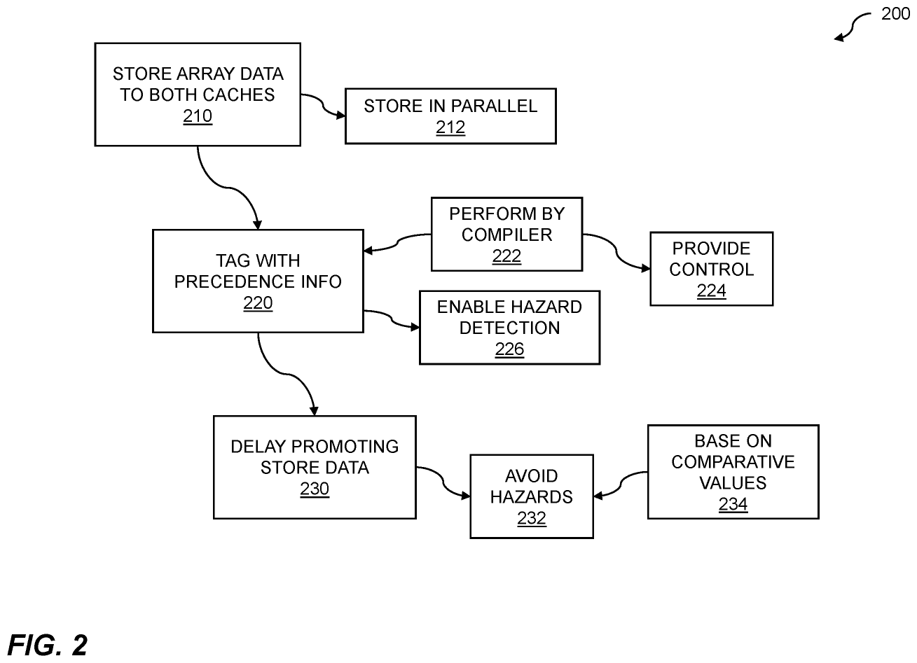

FIG. 2 is a flow diagram for maintaining data coherence. The data coherence can be maintained between a first data cache and a second data cache. Portions, collections, or clusters of compute elements (CEs), such as CEs assembled within a 2D array of CEs, can be configured to execute a variety of operations associated with programs. The operations can be based on tasks, and on subtasks that are associated with the tasks. The 2D array can further interface with other elements such as controllers, storage elements, ALUs, MMUs, GPUs, multiplier elements, and the like. The 2D array can be coupled to data caches such as a first data cache and a second data cache. The operations can accomplish a variety of processing objectives such as application processing, data manipulation, design and simulation, and so on. The operations can perform manipulations of a variety of data types including integer, real, and character data types; vectors and matrices; tensors; etc. Control can be provided to the array of compute elements on a cycle-by-cycle basis, where the control is based on a stream of wide control words generated by the compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence compute element results. The control words can further include precedence information, where the precedence information can be used to enable data coherence between the first data cache and the second data cache.

The control words, such as control words that include precedence information, can enable execution of a compiled program on the array of compute elements. The execution of the compiled program can be accomplished by maintaining coherence between the first data cache and the second data cache. The compute elements can access the first data cache and the second data cache, where the caches can store data required by the compiled program. The data caches enable a parallel processing architecture with dual load buffers. A two-dimensional array of compute elements is accessed, wherein each compute element within the array of compute elements is known to a compiler and is coupled to its neighboring compute elements within the array of compute elements. A first data cache is coupled to the array of compute elements, wherein the first data cache enables loading data to a first portion of the array of compute elements, and wherein the first data cache supports an address space. A second data cache is coupled to the array of compute elements, wherein the second data cache enables loading data to a second portion of the array of compute elements, and wherein the second data cache supports the address space. Instructions are executed within the array of compute elements, wherein instructions executed within the first portion of the array of compute elements use data loaded from the first data cache, and wherein instructions executed within the second portion of the array of compute elements use data loaded from the second data cache. The flow 200 includes storing 210 the store data to the first data cache and the second data cache. The storing can be accomplished by transferring the store data using a bus, a communication channel, nearest neighbor communication, and so on. The storing can be accomplished by transferring data as a quantity of bytes, one or more words, one or more blocks, a cache line, and the like. In the flow 200, the store data is stored to the first data cache and the second data cache in parallel 212. The storing the store data in parallel can be accomplished using unidirectional buses or communication channels, registers, etc.

The flow 200 includes tagging 220 the store data with precedence information. The precedence information can include a number, a relative value, a string, and so on. The precedence information can include a priority level such as high, medium, or low priority. The precedence information can be based on a countdown or “time to live”. A countdown tag can enable an element, such as a controller associated with the 2D array of compute elements, to track store data submitted to the first and the second data caches, a memory system, etc. The store data can be generated by tasks, subtasks, and so on that can be generated by a compiler. The store data that is generated by the tasks and subtasks can be tagged with the precedence information. In the flow 200, the tagging of the load requests is performed by the compiler 222. The compiler can include a general-purpose compiler, a hardware description-based compiler, a compiler written or “tuned” for the array of compute elements, a constraint-based compiler, a satisfiability-based compiler (SAT solver), and so on. In the flow 200, the compiler provides control 224 for compute elements on a cycle-by-cycle basis. A cycle can include an architectural cycle, a physical cycle such as a “wall clock” cycle, and so on. In embodiments, control for the compute elements can be enabled by a stream of wide control words generated by the compiler. The control words can include wide microcode control words. The length of a control word such as a microcode control word can be adjusted by compressing the control word. The compressing can be accomplished by recognizing situations where a compute element is unneeded by a task. Thus, control bits within the control word associated with the unneeded compute elements are not required for that compute element. Other compression techniques can also be applied. In embodiments, the control words can include the precedence information. In the flow 200, the precedence information enables 226 hazard detection. A hazard can include a data hazard, a structural or resource hazard, a control (e.g., branch) hazard, and so on. A hazard such as a data hazard can exist when a load (read) operation and a store (write) operation require access to the same memory, register, or storage address. Unless the ordering of the load and the store is coordinated, valid data can be overwritten, stale data can be read, and so on. In embodiments, the data hazards can include write-after-read, read-after-write, and write-after-write conflicts. The ordering of the load and the store can be based on the precedence information.

The flow 200 further includes delaying 230 promoting the store data. The promoting the store data can include queueing the store data for storing into a memory system, the first data cache and the second data cache, and so on. The delaying can include storing the store data in the first data queue and the second data queue. The delaying can be based on a number of cycles such as architectural cycles, physical cycles, and the like. In the flow 200, the delaying avoids hazards 232. The delaying can enable loading of data prior to the data being overwritten with new data, storing data prior to the data being required for loading by an operation, and so on. In the flow 200, the avoiding hazards is based on a comparative precedence value 234. The comparative precedence value can include a rank, a priority, a time to live, and the like. In a usage example, operations associated with tasks and subtasks are executing on the 2D array of compute elements. Data dependencies can exist between tasks and subtasks, such that some tasks and subtasks are required to be executed prior to execution of other tasks and subtasks. An operation with a higher precedence can be scheduled for execution prior to execution of a lower precedence operation.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

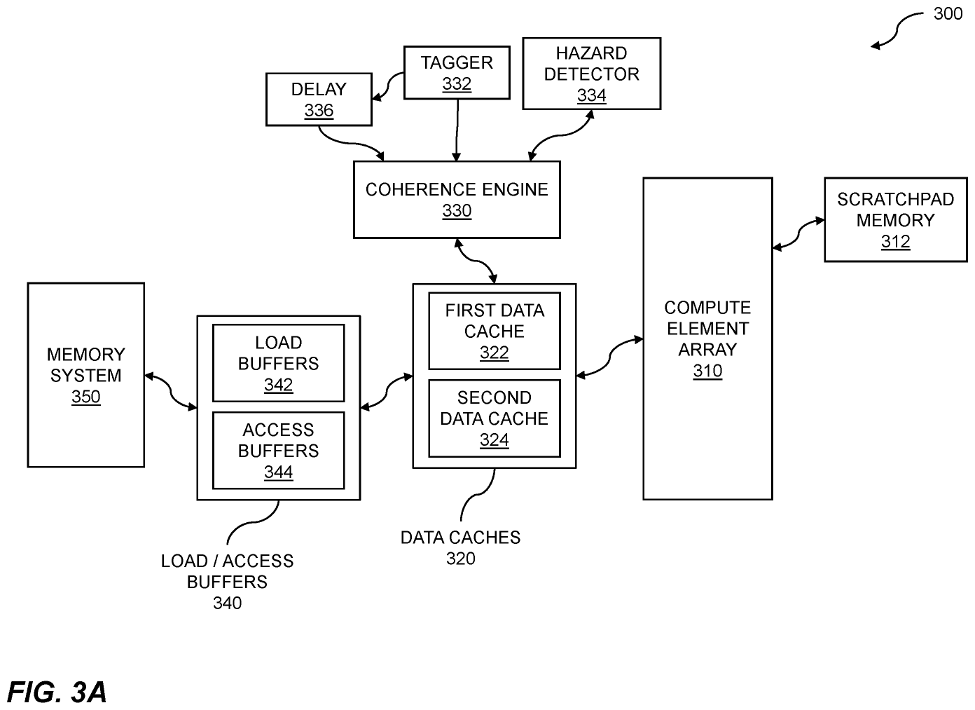

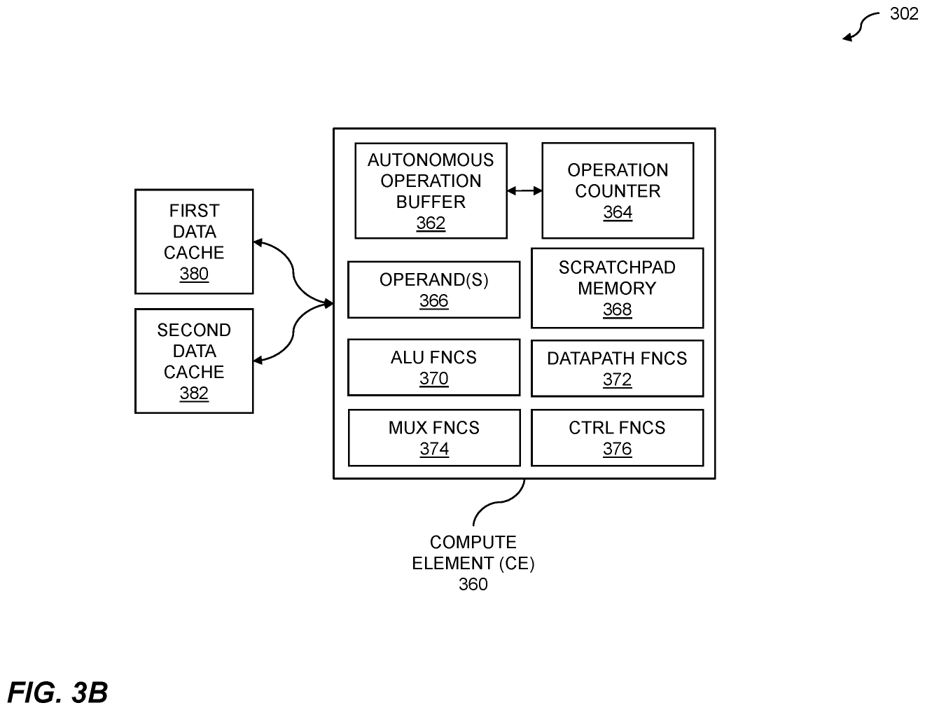

FIG. 3A is a system block diagram showing caches and buffers. The caches and buffers can be coupled to one or more compute elements within an array of compute elements. The array of compute elements can be configured to perform a variety of operations such as arithmetic and logical operations. The array of compute elements can be configured to perform higher level processing operations such as video, audio, and natural language processing operations. The array can be further configured for machine learning functionality, where the machine learning functionality can include a neural network implementation. A two-dimensional array of compute elements is accessed, wherein each compute element within the array of compute elements is known to a compiler and is coupled to its neighboring compute elements within the array of compute elements. A first data cache is coupled to the array of compute elements, wherein the first data cache enables loading data to a first portion of the array of compute elements, and wherein the first data cache supports an address space. A second data cache is coupled to the array of compute elements, wherein the second data cache enables loading data to a second portion of the array of compute elements, and wherein the second data cache supports the address space. Instructions are executed within the array of compute elements, wherein instructions executed within the first portion of the array of compute elements use data loaded from the first data cache, and wherein instructions executed within the second portion of the array of compute elements use data loaded from the second data cache.

The system block diagram 300 can include a compute element (CE) array 310. The compute element array can be based on two or more compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The compute element can be configured by providing control in the form of control words, where the control words are generated by a compiler. The compute elements can include one or more components, where the components can enable or enhance operations executed by the compute elements. The array of compute elements can further include elements such as arithmetic logic units (ALUs), memory management units (MMUs), multiplier elements, communications elements, etc.

The compute elements within the 2D array of compute elements can execute instructions associated with operations. The operations can include one or more operations associated with control words, where the control words are generated by the compiler. The operations can result from compilation of code to perform a task, a subtask, a process, and so on. The operations can be obtained from storage such as a memory system, cache memory, and so on. The operations can be loaded when the 2D array of compute elements is scheduled or configured, and the like. The operation can include one or more fields, operands, registers, etc. An operand can include an instruction that performs various computational tasks, such as a read-modify-write operation. A read-modify-write operation can include arithmetic operations; logical operations; array, matrix, and tensor operations; and so on. The operand can be used to perform an operation on the contents of registers, local storage, etc. The system block diagram can include a scratchpad memory 312. The scratchpad memory can include a small, high-speed memory collocated with or adjacent to one or more compute elements within the array of compute elements. The scratchpad memory can comprise 2R1 W storage elements, where the 2R1 W storage elements can be located within a compute element. The compute elements can further include components for performing various functions such as arithmetic functions, logical functions, etc.

Data required for operations executed by the compute elements (load data), and data generated by the executed operations (store data), can be obtained from various types of storage. In the block diagram 300, the data can be obtained from data caches 320. The data caches can include two or more caches, such as a first data cache 322 and a second data cache 324. In embodiments, the first data cache can enable loading data to a first portion of the array of compute elements. The first portion can include one or more compute elements. The first data cache can support an address space. The address space can include a space that can support addresses by an instruction being executed within the array of compute elements. In other embodiments, the second data cache can enable loading data to a second portion of the array of compute elements. The second data cache can support the address space. The second portion of the array of compute elements can include one or more compute elements, a portion of or all of the array elements not located within the first portion of the array, and the like. In embodiments, the first data cache and the second data cache can each comprise a level 1 (L1)/level 2 (L2) cache bank. The address space can include a common address space. In embodiments, the address space can be a common address space supported simultaneously by both the first data cache and the second data cache. The common address space can include an address space within a cache such as a multilevel cache. A multilevel cache can include levels of substantially similar or different sizes, access speeds, etc.

The system block diagram 300 can include a coherence engine 330. The coherence engine can be used to manage and maintain cache coherence for the 2D array of compute elements. Embodiments can include maintaining coherence between the first data cache and the second data cache. The maintaining coherence can include storing substantially similar store data, such as data be stored into a storage system such as a memory system, into the first data cache and the second data cache. The store data can originate within the array of compute elements. In embodiments, coherence can be maintained by storing store data from within the array of compute elements to both the first data cache and the second data cache. The storing the store data to the first and the second data caches can be accomplished sequentially, by storing blocks of data, and the like. In embodiments, the store data can be stored to the first data cache and the second data cache in parallel.

A variety of techniques can be used to enable cache coherence between the first data cache and the second data cache. The system block diagram 300 can include a tagging element or tagger 332. The tagger can be used to apply a tag to the store data. The tag can include a value, a label, and so on. In embodiments, the store data can be tagged with precedence information. The precedence information can include a data priority such as high priority or low priority, an order of the data for processing, and the like. In embodiments, the precedence information can be determined by the compiler. The compiler generates instructions based on compiling code associated with processing tasks and subtasks. The compiler can assign operations to compute elements within the 2D array of compute elements by providing one or more control words. In embodiments, the compiler can provide control for compute elements on a cycle-by-cycle basis. The compiler can direct data stored within the first data cache and the second data cache to and from processing elements within the 2D array. In other embodiments, cache lines in each level 2 (L2) cache of the first data cache and the second data cache can include an age counter. The age counter can be based on a number of cycles such as physical cycles, an amount of time (e.g., a “time to live”), etc.

The system block diagram 300 can include a hazard detector 334. The hazard detector can detect a hazard associated with loading data from the first data cache or the second data cache, storing data from data caches, and so on. A hazard can include overwriting valid data, reading invalid or stale data, and the like. Various types of hazards associated with loading and storing data can be detected. In embodiments, the hazards can include write-after-read, read-after-write, and write-after-write conflicts. Hazards can be avoided using a variety of techniques. In embodiments, the avoiding hazards can be based on a comparative precedence value. In a usage example, execution of an instruction generates store data to be stored at a location within the data caches. A second instruction requires data for processing, where the data is stored at the same location within the data caches. The second instruction can be assigned a higher precedence so that the second instruction can obtain needed data before the needed data is overwritten by the first instruction. The higher precedence associated with the second instruction can avoid the “read-after-write” hazard.

The system block diagram 300 can include a delay element 336. The delay element can delay a storage access instruction, where the delay can include a number of cycles such as physical cycles, an amount of time, and so on. Further embodiments include delaying the promoting of the store data. Promoting store data can include storing store data, such as data generated by executing an instruction within the 2D array of compute elements, to the first data cache, the second data cache, and the like. In embodiments, the delaying can avoid hazards. Discussed previously, the hazards can include read-before-write, write-after-read, etc. The avoiding hazards by delaying promoting the store data can be based on a comparative precedence value. The precedence value used to tag store data resulting from executing a first instruction can be compared to the precedence value used to tag store data required for execution of a second instruction. The delay can be introduced to ensure that valid data is read (loaded) before being overwritten (stored) by new data. The delaying can further be used to enable cache coherency. In embodiments, the compiler can generate a time delay to enable store coherency between the first data cache and the second data cache.

The first data cache and the second data cache can access a memory system through one or more system elements. The system elements can include buffers, switches, and so on. The system block diagram can include load/access buffers 340, where the load/access buffers can be associated with the first data cache and the second data cache. In embodiments, the first data cache and the second data cache can each include dedicated load buffers 342, crossbar switches (not shown), and access buffers 344. The load buffers can be located adjacent to or coupled to the 2D array of compute elements. The access buffers can be located adjacent to or coupled to a memory system. The memory system can comprise a cache such as a multilevel cache. In embodiments, a crossbar switch (not shown) can be positioned between the load buffers and the access buffers. The crossbar switch can be used to route data between the load buffers and the access buffers. The crossbar switch can further be used for shifting and rotating operations, multiplication and division by powers of two, etc. Data required for instructions executed by the compute elements (load data), and data generated by the executed operations (store data) can be obtained from various types of storage. In the block diagram 300, load data can be loaded (read) from a memory system 350. Store data can be stored (written) to the memory system 350. The memory system can be included within the 2D array of compute elements, coupled to the array, located remotely from the array, etc. The memory system can include a high-speed memory system. Contents of the memory system, such as requested data, can be located into one or more caches 320. The one or more caches can be coupled to a compute element, a plurality of compute elements, a portion of compute elements, and so on. The caches can include multilevel caches, such as L1, L2, and L3 caches. Other memory or storage can be coupled to the 2D array of compute elements.

FIG. 3B is a block diagram for a compute element. The compute element can represent a compute element within an array such as a two-dimensional array of compute elements. The array of compute elements can be configured to perform a variety of operations such as arithmetic, logical, matrix, and tensor operations. The array of compute elements can be configured to perform higher level processing operations such as video, audio, and natural language processing operations. The array can be further configured for machine learning functionality, where the machine learning functionality can include a neural network implementation. One or more compute elements can be configured for a parallel processing architecture with dual load buffers. A two-dimensional array of compute elements is accessed, wherein each compute element within the array of compute elements is known to a compiler and is coupled to its neighboring compute elements within the array of compute elements. A first data cache is coupled to the array of compute elements, wherein the first data cache enables loading data to a first portion of the array of compute elements, and wherein the first data cache supports an address space. A second data cache is coupled to the array of compute elements, wherein the second data cache enables loading data to a second portion of the array of compute elements, and wherein the second data cache supports the address space. Instructions are executed within the array of compute elements, wherein instructions executed within the first portion of the array of compute elements use data loaded from the first data cache, and wherein instructions executed within the second portion of the array of compute elements use data loaded from the second data cache.

The system block diagram 302 can include a compute element (CE) 360. The compute element can be configured by providing control in the form of control words, where the control words are generated by a compiler. The compiler can include a high-level language compiler, a hardware description language compiler, and so on. The compute element can include one or more components, where the components can enable or enhance operations executed by the compute element. The system block diagram 302 can include an autonomous operation buffer 362. The autonomous operation buffer can include at least two operations contained in one or more control words. The at least two operations can result from compilation by the compiler of code to perform a task, a subtask, a process, and so on. The at least two operations can be obtained from memory, loaded when the 2D array of compute elements is scheduled, and the like. The operations can include one or more fields, where the fields can include an instruction field, one or more or more operands, and so on. In embodiments, the system block diagram can further include additional autonomous operation buffers. The additional operation buffers can include at least two operations. The operations can be substantially similar to the operations loaded in the autonomous operation buffer or can be substantially different from the operations loaded in the autonomous operation buffer. In embodiments, the autonomous operation buffer contains sixteen operational entries.

The system block diagram can include an operation counter 364. The operation counter can act as a counter such as a program counter to keep track of which operation within the autonomous operation buffer is the current operation. In embodiments, the compute element operation counter can track cycling through the autonomous operation buffer. Cycling through the autonomous operation buffer can accomplish iteration, repeated operations, and so on. In embodiments, additional operation counters can be associated with the additional autonomous operation buffers. In embodiments, an operation in the autonomous operation buffer or in one or more of the additional autonomous operation buffers can comprise one or more operands 366, one or more data addresses for a memory such as a scratchpad memory, and the like. The operand can include an instruction that performs various computational tasks, such as a read-modify-write operation. A read-modify-write operation can include arithmetic operations; logical operations; array, matrix, and tensor operations; and so on. The block diagram 302 can include a scratchpad memory 368. The operand can be used to perform an operation on the contents of the scratchpad memory. Discussed below, the contents of the scratchpad memory can be obtained from a first data cache 380, a second data cache 382, local storage, remote storage, and the like. The scratchpad memory elements can include register files, which can include one or more 2R1 W register files. The one or more 2R1 W register files can be located within one compute element. The compute element can further include components for performing various functions. The block diagram 302 can include arithmetic logic unit (ALU) functions 370, which can include logical functions. The arithmetic functions can include multiplication, division, addition, subtraction, maximum, minimum, average, etc. The logical functions can include AND, OR, NAND, NOR, XOR, XNOR, NOT, logical and arithmetic SHIFT, ROTATE, and other logical operations. In embodiments, the logical functions and the mathematical functions can be accomplished using a component such as an arithmetic logic unit (ALU).

A compute element such as compute element 360 can communicate with one or more additional compute elements. The compute elements can be collocated within a 2D array of compute elements as the compute element or can be located in other arrays. The compute element can further be in communication with additional elements and components such as with local storage, with remote storage, and so on. The block diagram 302 can include datapath functions 372. The datapath functions can control the flow of data through a compute element, the flow of data between the compute element and other components, and so. The datapath functions can control communications between and among compute elements within the 2D array. The communications can be accomplished using a bus such as an industry standard bus, a ring bus, a network such as a wired or wireless computer network, etc. The block diagram 302 can include multiplexer MUX functions 374. The multiplexer, which can include a distributed MUX, can be controlled by the MUX functions. In embodiments, the ring bus can be implemented as a distributed MUX. The block diagram 302 can include control functions 376. The control functions can be used to configure or schedule one or more compute elements within the 2D array of compute elements. The control functions can enable one or more compute elements, disable one or more compute elements, and so on. A compute element can be enabled or disabled based on whether the compute element is needed for an operation within a given control cycle.

The contents of registers, operands, requested data, and so on can be obtained from various types of storage. In embodiments, the contents can be obtained from a memory system (not shown). The memory system can be shared among compute elements within the 2D array of compute elements. The memory system can be included within the 2D array of compute elements, coupled to the array, located remotely from the array, etc. The memory system can include a high-speed memory system. Contents of the memory system, such as requested data, can be loaded into the first data cache 380, the second data cache 382, or other caches. The first data cache and the second data cache can be coupled to a compute element, a plurality of compute elements, and so on. The caches can include multilevel caches (discussed below), such as L1, L2, and L3 caches. Other memory or storage can be coupled to the compute element.

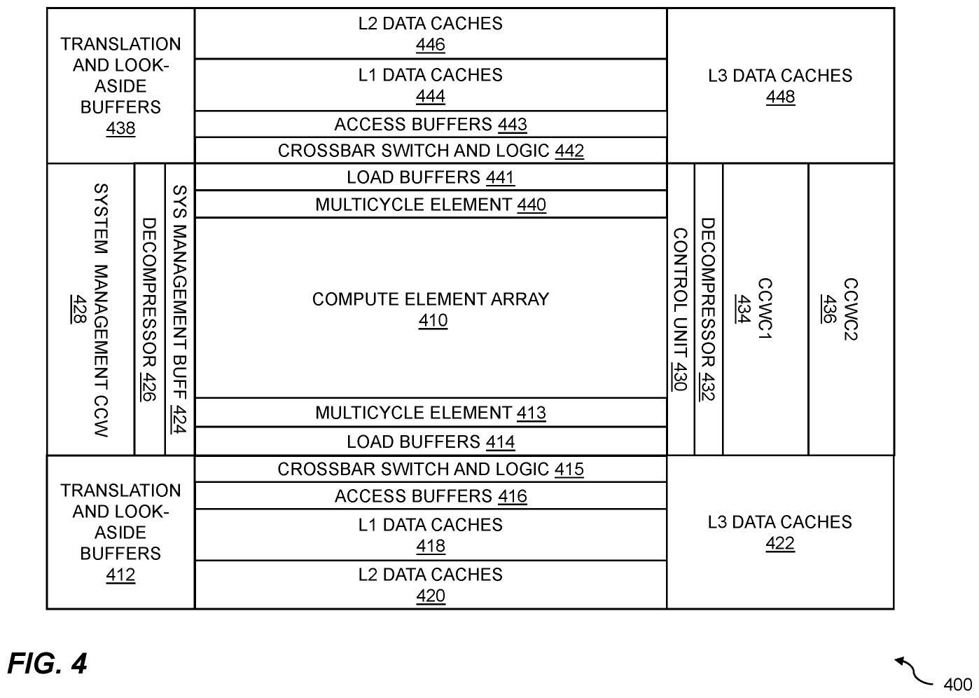

FIG. 4 illustrates a system block diagram for a highly parallel architecture with a shallow pipeline. The highly parallel architecture can comprise components including compute elements; processing elements; buffers; one or more levels of cache storage; system management; arithmetic logic units; multicycle elements for computing multiplication, division, and square root operations; and so on. The various components can be used to accomplish parallel processing of tasks, subtasks, and so on. The task processing is associated with program execution, job processing, application processing, etc. The task processing is enabled based on a parallel processing architecture with dual load buffers. A two-dimensional array of compute elements is accessed, wherein each compute element within the array of compute elements is known to a compiler and is coupled to its neighboring compute elements within the array of compute elements. A first data cache is coupled to the array of compute elements, wherein the first data cache enables loading data to a first portion of the array of compute elements, and wherein the first data cache supports an address space. A second data cache is coupled to the array of compute elements, wherein the second data cache enables loading data to a second portion of the array of compute elements, and wherein the second data cache supports the address space. Instructions are executed within the array of compute elements, wherein instructions executed within the first portion of the array of compute elements use data loaded from the first data cache, and wherein instructions executed within the second portion of the array of compute elements use data loaded from the second data cache.

A system block diagram 400 for a highly parallel architecture with a shallow pipeline is shown. The system block diagram can include a compute element array 410. The compute element array 410 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 400 can include translation and look-aside buffers such as translation and look-aside buffers 412 and 438. The translation and look-aside buffers can comprise memory caches, where the memory caches can be used to reduce storage access times.

The system block diagram 400 can include logic for load and store access order and selection. The logic for load and store access order and selection can include crossbar switch and logic 415 along with crossbar switch and logic 442. Crossbar switch and logic 415 can accomplish load and store access order and selection for the lower data cache blocks (418 and 420), and crossbar switch and logic 442 can accomplish load and store access order and selection for the upper data cache blocks (444 and 446). Crossbar switch and logic 415 enables high-speed data communication between the lower-half compute elements of compute element array 410 and data caches 418 and 420 using access buffers 416. Crossbar switch and logic 442 enables high-speed data communication between the upper-half compute elements of compute element array 410 and data caches 444 and 446 using access buffers 443. The access buffers 416 and 443 allow logic 415 and logic 442, respectively, to hold, load, or store data until any memory hazards are resolved. In addition, splitting the data cache between physically adjacent regions of the compute element array can enable the doubling of load access bandwidth, the reducing of interconnect complexity, and so on. While loads can be split, stores can be driven to both lower data caches 418 and 420 and upper data caches 444 and 446.

The system block diagram 400 can include lower load buffers 414 and upper load buffers 441. The load buffers can provide temporary storage for memory load data so that it is ready for low latency access by the compute element array 410. The system block diagram can include dual level 1 (L1) data caches, such as L1 data caches 418 and 444. The L1 data caches can be used to hold blocks of load and/or store data, such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 420 and 446. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 422 and 448. The L3 caches can be larger than the L2 and L1 caches and can include slower storage. Accessing data from L3 caches is still faster than accessing main storage. In embodiments, the L1, L2, and L3 caches can include 4-way set associative caches.

The system block diagram 400 can include lower multicycle element 413 and upper multicycle element 440. The multicycle elements (MEMs) can provide efficient functionality for operations that span multiple cycles, such as multiplication operations. The MEMs can provide further functionality for operations that can be of indeterminant cycle length, such as some division operations, square root operations, and the like. The MEMs can operate on data coming out of the compute element array and/or data moving into the compute element array. Multicycle element 413 can be coupled to the compute element array 410 and load buffers 414, and multicycle element 440 can be coupled to compute element array 410 and load buffers 441.

The system block diagram 400 can include a system management buffer 424. The system management buffer can be used to store system management codes or control words that can be used to control the array 410 of compute elements. The system management buffer can be employed for holding opcodes, codes, routines, functions, etc. which can be used for exception or error handling, management of the parallel architecture for processing tasks, and so on. The system management buffer can be coupled to a decompressor 426. The decompressor can be used to decompress system management compressed control words (CCWs) from system management compressed control word buffer 428 and can store the decompressed system management control words in the system management buffer 424. The compressed system management control words can require less storage than the uncompressed control words. The system management CCW component 428 can also include a spill buffer. The spill buffer can comprise a large static random-access memory (SRAM), which can be used to provide rapid support of multiple nested levels of exceptions.

The compute elements within the array of compute elements can be controlled by a control unit such as control unit 430. While the compiler, through the control word, controls the individual elements, the control unit can pause the array to ensure that new control words are not driven into the array. The control unit can receive a decompressed control word from a decompressor 432 and can drive out the decompressed control word into the appropriate compute elements of compute element array 410. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 434. CCWC1 can include a cache such as an L1 cache that includes one or more compressed control words. CCWC1 can be coupled to a further compressed control word store such as compressed control word cache 2 (CCWC2) 436. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 432 can be coupled between CCWC1 434 (now DCWC1) and CCWC2 436.

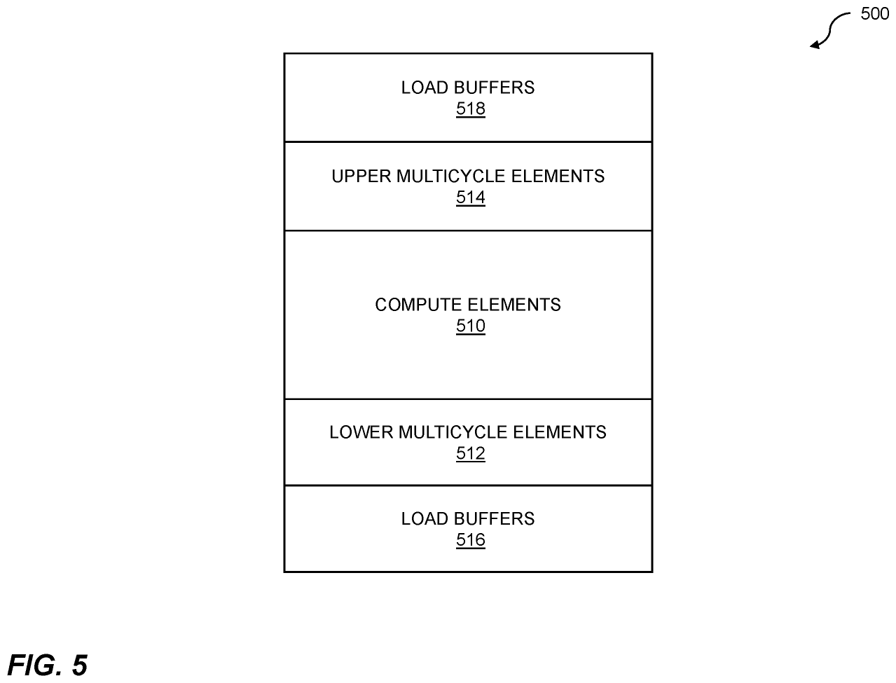

FIG. 5 shows compute element array detail 500. A compute element array can be coupled to a variety of components which enable the compute elements within the array to process one or more applications, tasks, subtasks, and so on. The components can access and provide data, perform specific high-speed operations, and the like. The compute element array and its associated components enable a parallel processing architecture with dual load buffers. The load buffers provide data for and receive data from instructions executed within the array of compute elements. The compute element array 510 can perform a variety of processing tasks, where the processing tasks can include operations such as arithmetic, vector, matrix, or tensor operations; audio and video processing operations; neural network operations; etc. The compute elements can be coupled to multicycle elements such as lower multicycle elements 512 and upper multicycle elements 514. The multicycle elements can provide functionality to perform, for example, high-speed multiplications associated with general processing tasks, multiplications associated with neural networks such as deep learning networks, multiplications associated with vector operations, and the like. The multiplication operations can span multiple cycles. The MEMs can provide further functionality for operations that can be of indeterminant cycle length, such as some division operations, square root operations, and the like.

The compute elements can be coupled to load buffers such as load buffers 516 and load buffers 518. The load buffers can be coupled to the L1 data caches as discussed previously. In embodiments, a crossbar switch (not shown) can be coupled between the load buffers and the data caches. The load buffers can be used to load storage access requests from the compute elements. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data memory and control word memory) can be performed. The memory systems can be free running and can continue to operate while the array is paused. Because multicycle latency can occur due to control signal transport that results in additional “dead time”, allowing the memory system to “reach into” the array and to deliver load data to appropriate scratchpad memories can be beneficial while the array is paused. This mechanism can operate such that the array state is known, as far as the compiler is concerned. When array operation resumes after a pause, new load data will have arrived at a scratchpad, as required for the compiler to maintain the statically scheduled model.

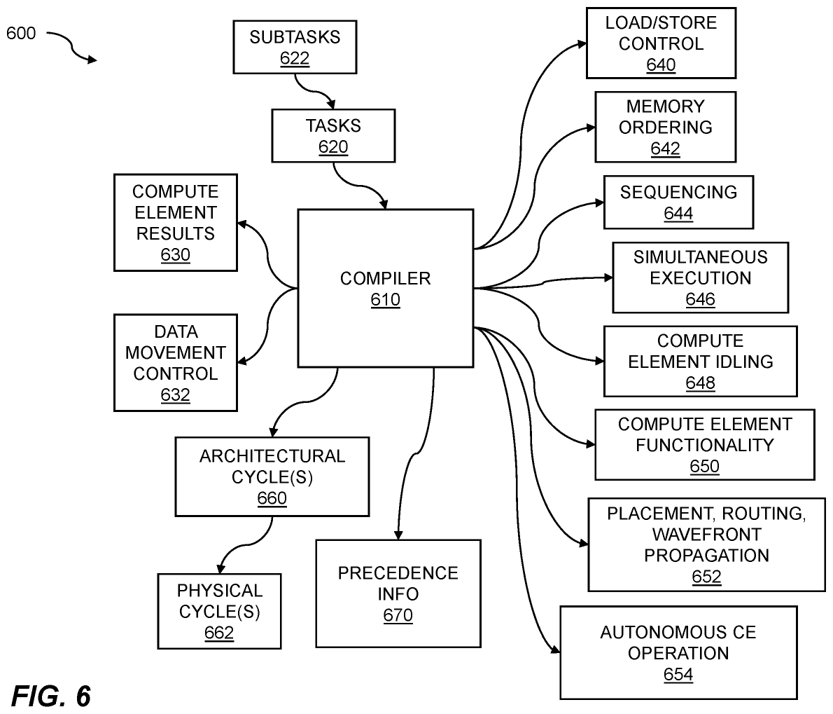

FIG. 6 illustrates a system block diagram for compiler interactions. Discussed throughout, compute elements within a 2D array are known to a compiler which can compile tasks and subtasks for execution on the array. The compiled tasks and subtasks are executed to accomplish task processing. A variety of interactions, such as placement of tasks, routing of data, and so on, can be associated with the compiler. The compiler interactions enable a parallel processing architecture using distributed register files. A two-dimensional array of compute elements is accessed, wherein each compute element within the array of compute elements is known to a compiler and is coupled to its neighboring compute elements within the array of compute elements. The array of compute elements is controlled on a cycle-by-cycle basis, wherein the controlling is enabled by a stream of wide control words generated by the compiler. Virtual registers are mapped to a plurality of physical register files distributed among one or more of the compute elements, wherein the mapping is performed by the compiler. Operations contained in the control words are executed, wherein the operations are enabled by at least one of the plurality of distributed physical register files.

The system block diagram 600 includes a compiler 610. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can generate a set of directions that can be provided to the compute elements and other elements within the array. The compiler can be used to compile tasks 620. The tasks can include a plurality of tasks which can be associated with a processing task. The tasks can further include a plurality of subtasks 622. The tasks can be based on an application such as a video processing or audio processing application. In embodiments, the tasks can be associated with machine learning functionality. The compiler can generate directions for handling compute element results 630. The compute element results can include results derived from arithmetic, vector, array, and matrix operations; Boolean operations; and so on. In embodiments, the compute element results are generated in parallel in the array of compute elements. Parallel results can be generated by compute elements when the compute elements can share input data, use independent data, and the like. The compiler can generate a set of directions that controls data movement 632 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler can provide directions for task and subtasks handling, input data handling, intermediate and result data handling, and so on. The compiler can further generate directions for configuring the compute elements, storage elements, control units, ALUs, and so on associated with the array. As previously discussed, the compiler generates directions for data handling to support the task handling. In the system block diagram, the data movement can include loads and stores 640 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, level 2 (L2) cache, level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 642. Memory data can be ordered based on task data requirements, subtask data requirements, and so on. The memory data ordering can enable parallel execution of tasks and subtasks.

In the system block diagram 600, the ordering of memory data can enable compute element result sequencing 644. In order for task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 646 of two or more potential compiled task outcomes based on the set of directions. The code that is compiled by the compiler can include branch points, where the branch points can include computations or flow control. Flow control transfers program execution to a different sequence of control words. Since the result of a branch decision, for example, is not known a priori, the initial operations associated with both paths are encoded in the currently executing control word stream. When the correct result of the branch is determined, then the sequence of control words associated with the correct branch result continues execution, while the operations for the branch path not taken are halted and side effects may be flushed. In embodiments, the two or more potential branch paths can be executed on spatially separate compute elements within the array of compute elements.

The system block diagram includes compute element idling 648. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 650. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 652 within the array of compute elements. The compiler can generate directions or instructions that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. Computation wave-front propagation can implement and control how execution of tasks and subtasks proceeds through the array of compute elements. In the system block diagram 600, the compiler 610 can enable autonomous compute element (CE) operation 654. As discussed throughout, the autonomous operation is set up by one or more control words, which are generated by the compiler, that enable a CE to complete an operation autonomously, that is, not under direct compiler control. An operation that can be completed autonomously can include a load-modify-write operation. The load-modify-write operation, among other operations, can be executed without the requirement to receive additional control words.

In the system block diagram, the compiler can control architectural cycles 660. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. In embodiments, an architectural cycle can occur when a control word is available to be pipelined into the array of compute elements and when all data dependencies are met. That is, the array of compute elements does not have to wait for either dependent data to load or for a full memory queue to clear. In the system block diagram, the architectural cycle can include one or more physical cycles 662. A physical cycle can refer to one or more cycles at the element level required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. Various operand sizes can be used. In embodiments, the operand size can include bytes, half-words, words, and double-words.

The system block diagram includes precedence information 670. The precedence information can be used in part to maintain coherence between the first data cache and the second data cache with regard to store data. The store data can include store data from within the array of compute elements, where the store data can include results from one or more operations performed by one or more compute elements. In embodiments, the coherence can be maintained by storing store data from within the array of compute elements to both the first data cache and the second data cache. The storing to the first data cache and to the second data cache can be performed sequentially; in words, blocks, or segments; and so on. In embodiments, the store data can be stored to the first data cache and to the second data cache in parallel. The store data can be tagged. In embodiments, the store data can be tagged with precedence information. The precedence information can be associated with a task or subtask, an operation, and the like. The precedence information can include an operation class, an order of operation, a time constraint, etc. In embodiments, the precedence information can be determined by the compiler.

Discussed previously and throughout, the compiler can generate control information in the form of control words, where the control words can be associated with operations, tasks, subtasks, and so on. In embodiments, the compiler can provide control for compute elements on a cycle-by-cycle basis. The cycle-by-cycle basis can include an architectural system, a physical cycle, and the like. A physical cycle can include an amount of time (“wall clock” time). In embodiments, control for the compute elements can be enabled by a stream of wide control words generated by the compiler. The control words can configure compute elements, provide operations to implement tasks and subtasks, etc. In embodiments, the control words can include the precedence information. Discussed previously, the precedence information can prescribe an order of operations such as load (read) operations, store (write) operations, and so on. In embodiments, the precedence information can enable hazard detection. A hazard, which can occur when operations such as load and store operations occur out of order, can include write-after-read, read-after-write, and write-after-write conflicts. Further embodiments include delaying promoting the store data. The delaying promoting the store data can include delaying operations such as write-back from the first data cache and/or the second data cache to a storage system such as a memory system, thereby avoiding hazards. In embodiments, the avoiding hazards can be based on a comparative precedence value.

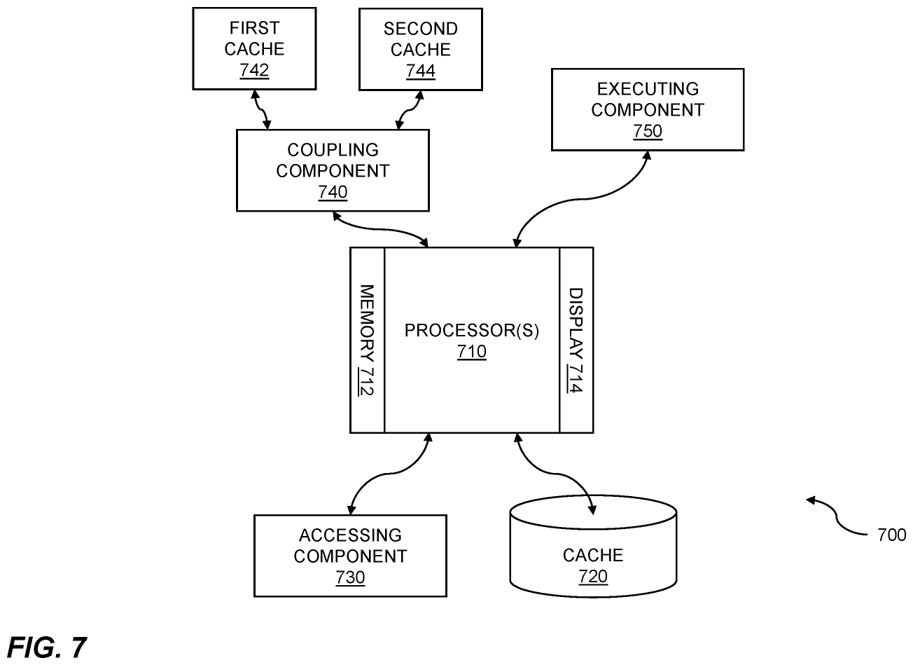

FIG. 7 is a system diagram for parallel processing. The parallel processing is enabled by a parallel processing architecture with dual load buffers. The system 700 can include one or more processors 710, which are attached to a memory 712 which stores instructions. The system 700 can further include a display 714 coupled to the one or more processors 710 for displaying data; coherence information; intermediate steps; directions; control words; compressed control words; control words implementing Very Long Instruction Word (VLIW) functionality; topologies including systolic, vector, cyclic, spatial, streaming, or VLIW topologies; and so on. In embodiments, one or more processors 710 are coupled to the memory 712, wherein the one or more processors, when executing the instructions which are stored, are configured to: access a two-dimensional array of compute elements, wherein each compute element within the array of compute elements is known to a compiler and is coupled to its neighboring compute elements within the array of compute elements; couple a first data cache to the array of compute elements, wherein the first data cache enables loading data to a first portion of the array of compute elements, and wherein the first data cache supports an address space; couple a second data cache to the array of compute elements, wherein the second data cache enables loading data to a second portion of the array of compute elements, and wherein the second data cache supports the address space; and execute instructions within the array of compute elements, wherein instructions executed within the first portion of the array of compute elements use data loaded from the first data cache, and wherein instructions executed within the second portion of the array of compute elements use data loaded from the second data cache. The compute elements can include compute elements within one or more integrated circuits or chips; compute elements or cores configured within one or more programmable chips such as application specific integrated circuits (ASICs); field programmable gate arrays (FPGAs); heterogeneous processors configured as a mesh; standalone processors; etc.

The system 700 can include a cache 720. The cache 720 can be used to store data such as data associated with a first data cache and a second data cache. The cache can further be used for mapping virtual register files to physical register files based on 2R1 W register files; mapping of the virtual registers including renaming by the compiler; storing directions to compute elements, control words, intermediate results, microcode, and branch decisions; and so on. The first data cache and the second cache can comprise small, local, easily accessible memories available to one or more compute elements. The first and second data caches can enable load data to a first portion of the array of compute elements and to a second portion of the array of compute elements, respectively. The first data cache and the second data cache support an address space. In embodiments, the address space can be a common address space supported simultaneously by both the first data cache and the second data cache. Embodiments include storing relevant portions of a control word within the first data cache and the second data cache, each of which is associated with the array of compute elements. The caches can be accessible to one or more compute elements within a first portion and a second portion of the array. The caches can include a dual read, single write (2R1 W) cache. That is, a 2R1 W cache can enable two read operations and one write operation contemporaneously without the read and write operations interfering with one another.

The system 700 can include an accessing component 730. The accessing component 730 can include control logic and functions for accessing a two-dimensional (2D) array of compute elements. Each compute element within the array of compute elements is known to a compiler and is coupled to its neighboring compute elements within the array of compute elements. A compute element can include one or more processors, processor cores, processor macros, and so on. Each compute element can include an amount of local storage. The local storage may be accessible to one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX).

The system 700 can include a coupling component 740. The coupling component 740 can include control and functions for coupling a data cache to the array of compute elements. More than one data cache can be coupled by the coupling component. The system 700 can include a first data cache 742. The coupling component can further include control and functions for coupling the first data cache 742 to the array of compute elements, wherein the first data cache enables loading data to a first portion of the array of compute elements, and wherein the first data cache supports an address space. The first portion of the array of compute elements can include one or more compute elements. The system 700 can include a second data cache 744. The coupling component can further include control and functions for coupling the second data cache 744 to the array of compute elements, wherein the second data cache enables loading data to a second portion of the array of compute elements, and wherein the second data cache supports the address space. The second portion of the array of compute elements can include one or more compute elements, the remainder of the compute elements not allocated to the first portion, and so on. In embodiments, the address space can be a common address space supported simultaneously by both the first data cache and the second data cache. Discussed previously and throughout, the first data cache and the second data cache can include a dual read, single write (2R1 W) cache. Embodiments can further include maintaining coherence between the first data cache and the second data cache. The coherence can include data coherence, temporal coherence, and so on. In embodiments, the coherence can be maintained by storing store data from within the array of compute elements to both the first data cache and the second data cache. The store data can include data processed by one or more compute elements within the array of compute elements that designated by a store operation for writing to a storage device or system. The store data can be stored to the first data cache and the second data cache in parallel, sequentially, etc.

The system 700 can include an executing component 750. The executing component 750 can include control and functions for executing instructions within the array of compute elements, wherein instructions executed within the first portion of the array of compute elements use data loaded from the first data cache, and wherein instructions executed within the second portion of the array of compute elements use data loaded from the second data cache. The instructions can be associated with control words generated by the compiler. The control words can be provided on a cycle-by-cycle basis. The control words that are generated can be associated with tasks, subtasks, and so on that perform a variety of operations. The operations that can be performed can include arithmetic operations, Boolean operations, matrix operations, neural network operations, and the like. The operations can be executed based on the control words generated by the compiler.

The control words can be based on low-level control words such as assembly language words, microcode words, firmware words, and so on. The control words can be variable length, such that a different number of operations for a differing plurality of compute elements can be conveyed in each control word. The control of the array of compute elements on a cycle-by-cycle basis can include configuring the array to perform various compute operations. In embodiments, the stream of wide control words comprises variable length control words generated by the compiler. In embodiments, the stream of wide control words generated by the compiler provides direct fine-grained control of the 2D array of compute elements. The compute operations can include a read-modify-write operation. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control word can enable machine learning functionality for the neural network topology.

The control words can be provided to a control unit where the control unit can control the operations of the compute elements within the array of compute elements. Operation of the compute elements can include configuring the compute elements, providing data to the compute elements, routing and ordering results from the compute elements, and so on. In embodiments, the same decompressed control word can be executed on a given cycle across the array of compute elements. The control words can be decompressed to provide control on a per compute element basis, where each control word can be comprised of a plurality of compute element control groups or bunches. One or more control words can be stored in a compressed format within a memory such as a cache. The compression of the control words can greatly reduce storage requirements. In embodiments, the control unit can operate on decompressed control words. The executing operations contained in the control words can include distributed execution of operations. In embodiments, the distributed execution of operations can occur in two or more compute elements within the array of compute elements. Recall that the mapping of the virtual registers can include renaming by the compiler. The executing is enabled by the common address space supported by the first data cache and the second data cache. The common address space enables coherence between the first data cache and the second data cache.

The system 700 can include a computer program product embodied in a non-transitory computer readable medium for parallel processing, the computer program product comprising code which causes one or more processors to perform operations of: accessing a two-dimensional array of compute elements, wherein each compute element within the array of compute elements is known to a compiler and is coupled to its neighboring compute elements within the array of compute elements; coupling a first data cache to the array of compute elements, wherein the first data cache enables loading data to a first portion of the array of compute elements, and wherein the first data cache supports an address space; coupling a second data cache to the array of compute elements, wherein the second data cache enables loading data to a second portion of the array of compute elements, and wherein the second data cache supports the address space; and executing instructions within the array of compute elements, wherein instructions executed within the first portion of the array of compute elements use data loaded from the first data cache, and wherein instructions executed within the second portion of the array of compute elements use data loaded from the second data cache.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for parallel processing comprising:
accessing a two-dimensional array of compute elements, wherein each compute element within the array of compute elements is known to a compiler and is coupled to its neighboring compute elements within the array of compute elements;
coupling a first data cache to the array of compute elements, wherein the first data cache enables loading data to a first portion of the array of compute elements, and wherein the first data cache supports an address space;
coupling a second data cache to the array of compute elements, wherein the second data cache enables loading data to a second portion of the array of compute elements, and wherein the second data cache supports the address space; and
executing instructions within the array of compute elements, wherein instructions executed within the first portion of the array of compute elements use data loaded from the first data cache, and wherein instructions executed within the second portion of the array of compute elements use data loaded from the second data cache.

2. The method of claim 1 wherein the address space is a common address space supported simultaneously by both the first data cache and the second data cache.

3. The method of claim 1 further comprising maintaining coherence between the first data cache and the second data cache.

4. The method of claim 3 wherein the coherence is maintained by storing store data from within the array of compute elements to both the first data cache and the second data cache.

5. The method of claim 4 wherein the store data is stored to the first data cache and the second data cache in parallel.

6. The method of claim 4 wherein the store data is tagged with precedence information.

7. The method of claim 6 wherein the precedence information is determined by the compiler.

8. The method of claim 7 wherein the compiler provides control for compute elements on a cycle-by-cycle basis.

9. The method of claim 8 wherein control for the compute elements is enabled by a stream of wide control words generated by the compiler.

10. The method of claim 9 wherein the control words include the precedence information.

11. The method of claim 6 wherein the precedence information enables hazard detection.

12. The method of claim 6 further comprising delaying promoting the store data.

13. The method of claim 12 wherein the delaying avoids hazards.

14. The method of claim 13 wherein the avoiding hazards is based on a comparative precedence value.

15. The method of claim 13 wherein the hazards include write-after-read, read-after-write, and write-after-write conflicts.

16. The method of claim 3 wherein the first data cache and the second data cache each comprise an L1/L2 cache bank.

17. The method of claim 16 wherein cache lines in each L2 of the first data cache and the second data cache includes an age counter.

18. The method of claim 17 wherein the age counter establishes precedence for a unified L3 cache coupled to the first data cache and the second data cache.

19. The method of claim 16 wherein the L1/L2 cache bank employs a write-back policy.

20. The method of claim 19 wherein the compiler generates a time delay to enable store coherence between the first data cache and the second data cache.

21. The method of claim 3 wherein the first data cache and the second data cache each includes dedicated load buffers, crossbar switches, and access buffers.

22. A computer program product embodied in a non-transitory computer readable medium for parallel processing, the computer program product comprising code which causes one or more processors to perform operations of:
accessing a two-dimensional array of compute elements, wherein each compute element within the array of compute elements is known to a compiler and is coupled to its neighboring compute elements within the array of compute elements;
coupling a first data cache to the array of compute elements, wherein the first data cache enables loading data to a first portion of the array of compute elements, and wherein the first data cache supports an address space;
coupling a second data cache to the array of compute elements, wherein the second data cache enables loading data to a second portion of the array of compute elements, and wherein the second data cache supports the address space; and
executing instructions within the array of compute elements, wherein instructions executed within the first portion of the array of compute elements use data loaded from the first data cache, and wherein instructions executed within the second portion of the array of compute elements use data loaded from the second data cache.

23. A computer system for parallel processing comprising:
a memory which stores instructions;
one or more processors coupled to the memory, wherein the one or more processors, when executing the instructions which are stored, are configured to:
access a two-dimensional array of compute elements, wherein each compute element within the array of compute elements is known to a compiler and is coupled to its neighboring compute elements within the array of compute elements;
couple a first data cache to the array of compute elements, wherein the first data cache enables loading data to a first portion of the array of compute elements, and wherein the first data cache supports an address space;
couple a second data cache to the array of compute elements, wherein the second data cache enables loading data to a second portion of the array of compute elements, and wherein the second data cache supports the address space; and
execute instructions within the array of compute elements, wherein instructions executed within the first portion of the array of compute elements use data loaded from the first data cache, and wherein instructions executed within the second portion of the array of compute elements use data loaded from the second data cache.
